(19) United States
(12) Patent Application Publication
(10) Pub. No.: US 2026/0264986 A1
(43) Pub. Date: Sep. 10, 2026

(54) WAREHOUSE AUTOMATION SYSTEM AND METHODS

(71) Applicant: Ocado Innovation Limited, Hatfield (GB)

(72) Inventors: Fan CHEN, Oklahoma City, OK (US); Theepan YOGANATHAN, Ajax (CA)

(21) Appl. No.: 19/075,468

(22) Filed: Mar. 10, 2025

(51) Int. Cl. B65G 1/137; G06Q 10/047; H04W 4/35

(52) U.S. Cl. CPC B65G 1/1375; G06Q 10/047; H04W 4/35

(57) ABSTRACT

There is provided a method of forming an association between a mobile terminal and a first autonomous vehicle. When such an association is made then the display of the first autonomous vehicle is mirrored on the mobile terminal. After one or more tasks gave been performed then the mobile terminal will be associated with a second mobile terminal and the display of the second autonomous vehicle will be mirrored on the mobile terminal.

The disclosure relates to an autonomous vehicle, and in particular to methods by which associates interact with autonomous vehicles in storage environments such as, for example, warehouses.

### BACKGROUND

It is known to use autonomous vehicles in warehouses, and other similar storage environments, to transport products. The products may be transported as a part of a number of different processes, for example, restocking, picking, counting, sorting, moving, and packing product items into customer orders and shipments. US9834380, the contents of which are hereby enclosed by reference in its entirety, discloses an example of such an autonomous vehicle.

FIG. 1 shows a schematic depiction of an autonomous vehicle 102. As illustrated, one or more autonomous vehicles 102, often referred to in the industry as picking carts, can work alongside one or more warehouse operators 104 to move inventory around a warehouse. The autonomous vehicles 102 are intended to assist in most warehouse tasks, such as picking, re-stocking, moving, sorting, and counting or verifying products. The autonomous vehicles 102 can display information to the operator 104 through the use of a screen 106 and/or onboard visual and/or audible indicators that improve the performance of the operators 104.

### SUMMARY

According to a first aspect of the present disclosure there is provided a computer implemented method comprising: making an association between a first mobile terminal and a first autonomous vehicle; on the completion of a task performed in conjunction with the first autonomous vehicle, associating the first mobile terminal with a second autonomous vehicle; and transmitting data to the first mobile terminal such that the first mobile terminal mirrors the display of the second autonomous vehicle.

The automatic association of the mobile terminal with the second autonomous vehicle simplifies the process for an operator logging in to an autonomous vehicle. Removing the need for the operator to log in, for example by entering a PIN or scanning a code, saves time and increases the efficiency of operation.

The first mobile terminal may display the destination location of the second autonomous vehicle. The first mobile terminal displays routing information to the destination location of the second autonomous vehicle. This enables the operator of the first mobile terminal to move efficiently to the destination that the second autonomous vehicle such that the operator can then perform one or more tasks in conjunction with the second autonomous vehicle.

The first mobile terminal may display information relating to a task to be performed in conjunction with the second autonomous vehicle. In one example, the first mobile terminal may display information relating to a product item to be picked to the second autonomous vehicle. Alternatively, or in addition, the first mobile terminal may display information relating to a storage location of a product item to be picked to the second autonomous vehicle. Thus, the operator of the first mobile terminal can be informed of the next task to be performed before they rendezvous with the second autonomous vehicle.

According to a second aspect of the present disclosure there is provided a system comprising one or more processors, a plurality of autonomous vehicles and one or more mobile terminals, the system being configured, in use, to make an association between a first mobile terminal and a first autonomous vehicle; on the completion of a task performed in conjunction with the first autonomous vehicle, associate the first mobile terminal with a second autonomous vehicle; transmit data to the first mobile terminal such that the first mobile terminal mirrors the display of the second autonomous vehicle.

The data transmitted to the first mobile terminal may comprise the destination location of the second autonomous vehicle. Additionally, or in the alternative, the data transmitted to the first mobile terminal may comprise routing information to the destination location of the second autonomous vehicle.

The data transmitted to the first mobile terminal may comprise information relating to a task to be performed in conjunction with the second autonomous vehicle. Additionally, or in the alternative, the data transmitted to the first mobile terminal comprises information relating to a product item to be picked to the second autonomous vehicle. This may comprise information relating to a storage location of a product item to be picked to the second autonomous vehicle.

According to a third aspect of the present disclosure there is provided a non-transitory machine readable storage medium comprising machine-readable instructions that cause: an association to be made between a first mobile terminal and a first autonomous vehicle; an association to be made between the first mobile terminal and a second autonomous vehicle on the completion of a task performed in conjunction with the first autonomous vehicle; and data to be transmitted to the first mobile terminal such that the first mobile terminal mirrors the display of the second autonomous vehicle.

### BRIEF DESCRIPTION OF THE DRAWINGS

Embodiments of the invention will now be described by way of example only with reference to the accompanying drawings, in which like reference numbers designate the same or corresponding parts, and in which:

FIG. 1 shows a schematic depiction of an autonomous vehicle;

FIG. 2 shows a schematic depiction of an exemplary graphical user interface that may be displayed;

FIG. 3 shows a schematic depiction of a storage environment;

FIG. 4 shows a schematic depiction of an example of an operator which has been assigned to a first autonomous vehicle;

FIG. 5 shows a schematic depiction of the computing platform and the storage environment;

FIG. 6 shows a schematic depiction of a method according to an example of the present disclosure; and

FIG. 7 shows a schematic depiction of a computer device.

### DETAILED DESCRIPTION

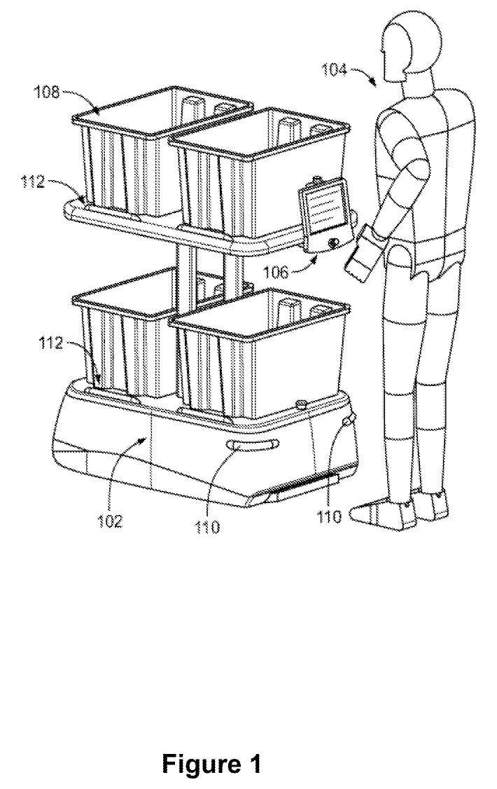

Referring still to FIG. 1, the autonomous vehicles 102 may be configured to carry one or many similar or distinct storage receptacles 108, often in the form of totes or boxes, that can be used to hold one or more different products. These storage receptacles 108 may be removable from the enhanced cart 102. In some cases, each receptacle 108 can be used as a separate picking location (i.e., one receptacle 108 is a single order). In other cases, the receptacles 108 can be used for batch picking (i.e., each receptacle 108 can contain multiple complete or partial orders).

The autonomous vehicle 102 comprises a screen 106 which may be configured to provide a user interface. The user interface may present to an associate information as to the product item to be picked, the location of the product item to be picked within the warehouse, etc. Information may also be provided to an associate using alternative means. For example, lighting on the autonomous vehicle may be used to light up the source and/or the destination of any products being placed into or taken out of the cart's storage receptacles 108. FIG. 1 shows lighting places 110 at the rear of the cart 102 similar to car tail lights and also lights 112 below each storage receptacle 108 location. This lighting may change colour based upon the task, so that the associate 104 has to look minimally or not at all at the screen 106 for instructions.

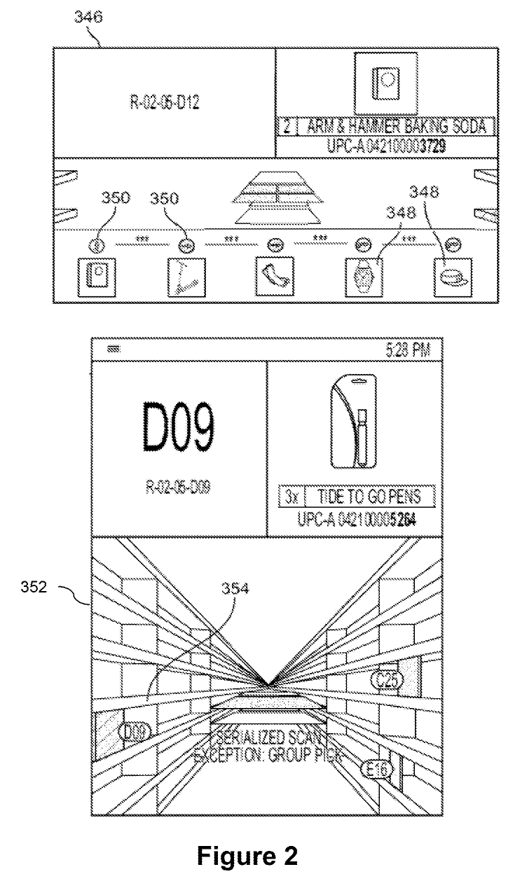

The operator may be provided with a mobile device which comprises a display screen. The screen of the operator mobile device may display some or all of the information displayed on the screen 106 of the autonomous vehicle. FIG. 2 shows a schematic depiction of an exemplary graphical user interface that may be displayed on the screen 106 of the autonomous vehicle or on a mobile device screen. A first exemplary display 346 shows the items to pick 348 and the direction of those items 350. A second exemplary display 352 shows the bins 354 from which each item 348 needs to be picked. The display 352 may also contain additional information, such as the locations of bins of the following items to be picked and the number of each item to be picked. It should be understood that the display images shown on the display screen may change depending on the task that is being performed, the action(s) required of an operator, other contexts, etc.

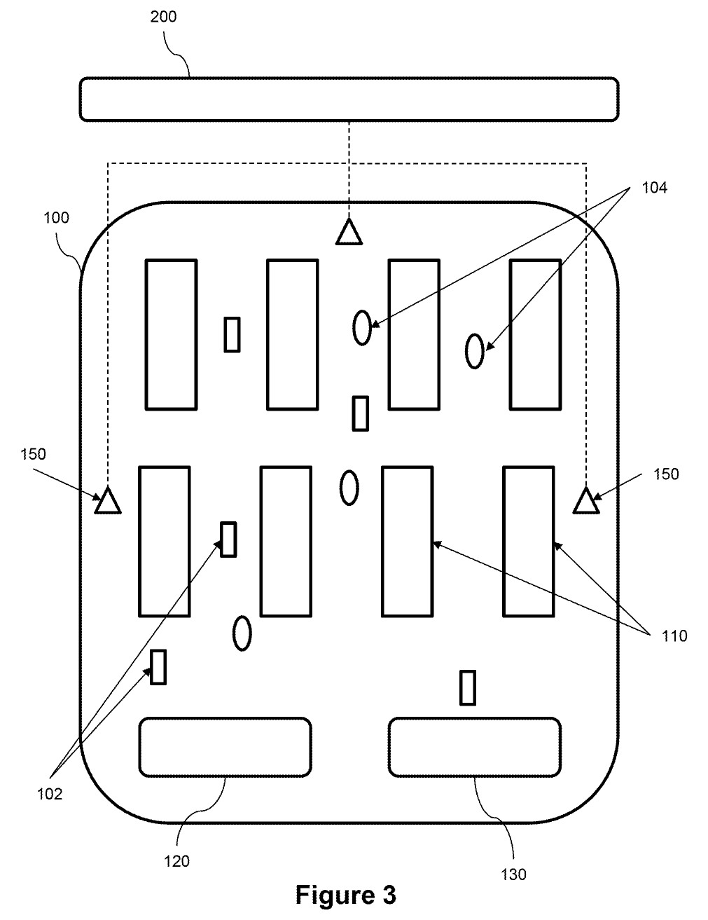

FIG. 3 shows a schematic depiction of a storage environment 100 (for example, a warehouse) which comprises a plurality of autonomous vehicles 102 which operate amongst a plurality of storage locations 110. The storage locations may comprise shelving, racking or other structures which can store product eaches in boxes or containers, directly on shelving or in some other manner. The storage environment 100 also comprises an induct area 120 and a packing area 130. The induct area receives product eaches from suppliers such that the product eaches can then be transferred to one or more storage locations 110 within the storage environment such that the product eaches can be picked subsequently in response to customer orders. The storage environment 100 also comprises a packing area 130 such that items that have been picked from the storage locations can be grouped into a number of customer orders such that each customer order can be packed and then dispatched. The storage environment 100 further comprises one or more wireless base stations 150, each of which are communicably connected to a computing platform 200. The one or more wireless base stations 150 may comprise WiFi access points, or base stations implementing a 3GPP-based wireless technology, such as, for example, LTE.

The computing platform 200 may be a server computer (or computers) located within the storage environment or alternatively the computing platform may comprise a remotely located server computer (or computers) or a cloud computing platform. The computing platform can communicate with each of the plurality of autonomous vehicles via one of the wireless base stations.

The computing platform receives a plurality of customer orders and then creates a list of tasks to be performed within the storage environment such that the customer orders can be fulfilled. The computing platform may also receive a list of product eaches that will be received at the induct area 120 and may consequently create a list of tasks to be performed within the storage environment such that the received product eaches can be inducted into the storage environment and stored at one or more of the storage locations. The efficient operation of the storage environment may require that for one or more product eaches are moved from a first storage location to a second storage location, for example to consolidate stock, to prevent congestion developing at points in the warehouse, etc. The computing platform may create a list of tasks that are necessary to perform such product movements. The computing platform may create one or more further lists of tasks that are required to perform other functions that are required for the efficient operation of the storage environment.

One or more operators 104 may be present in the storage environment such that they are able to interact with one or more of the autonomous vehicles 102. In some instances, an operator may be assigned to a single autonomous vehicle, for example to pick an item from a storage location and to place it into a tote on the autonomous vehicle or to transfer multiple product items from one or more totes on the autonomous vehicle to one or more storage locations. In some instances, an operator may be assigned to multiple autonomous vehicles such that product eaches may be transferred from a first autonomous vehicle to one or more further autonomous vehicles.

In some instances, it may be necessary for multiple operations to take place at the same location within the storage environment. To save time, it may be efficient to assign multiple operators to perform those operations. For example, multiple operators may be assigned to a single autonomous vehicle to pick multiple product eaches to a tote or to transfer multiple product items from one or more totes on the autonomous vehicle to one or more totes or shelved in a storage location. In a further example, multiple operators may be assigned to multiple autonomous vehicles such that product eaches may be transferred from a first autonomous vehicle to one or more further autonomous vehicles.

The computing system will then assign a list of tasks to each of the autonomous vehicles operating in the storage environment. Similarly, a list of tasks will be assigned to each of the operators who are scheduled to be present in the storage environment. Each of the lists of tasks are ordered such that the autonomous vehicles and the operators function efficiently. An example of how to assign tasks, and how operators can be assigned from a first autonomous vehicle to a second autonomous vehicle, is disclosed in US11635757.

When an autonomous vehicle begins to carry out the tasks that have been assigned to it, it will navigate to a location within the storage environment which is associated with the respective task. At that location, one or more operators will co-operate with the autonomous vehicle such that the task(s) can be completed. The autonomous vehicle will then navigate to a further location such that further tasks can be completed. It should be understood that in order to optimise the efficiency of an operator, the time that an operator spends interacting with an autonomous vehicle whilst performing a task should be maximised and the time that an operator spends walking between different locations to perform a task should be minimised. Thus, an operator is unlikely to follow the same autonomous vehicle through the storage environment and performing tasks with that autonomous vehicle for a prolonged period of time. It is more common that an operator will be frequently reassigned from one autonomous vehicle to a further autonomous vehicle so as to reduce the time that they spend walking.

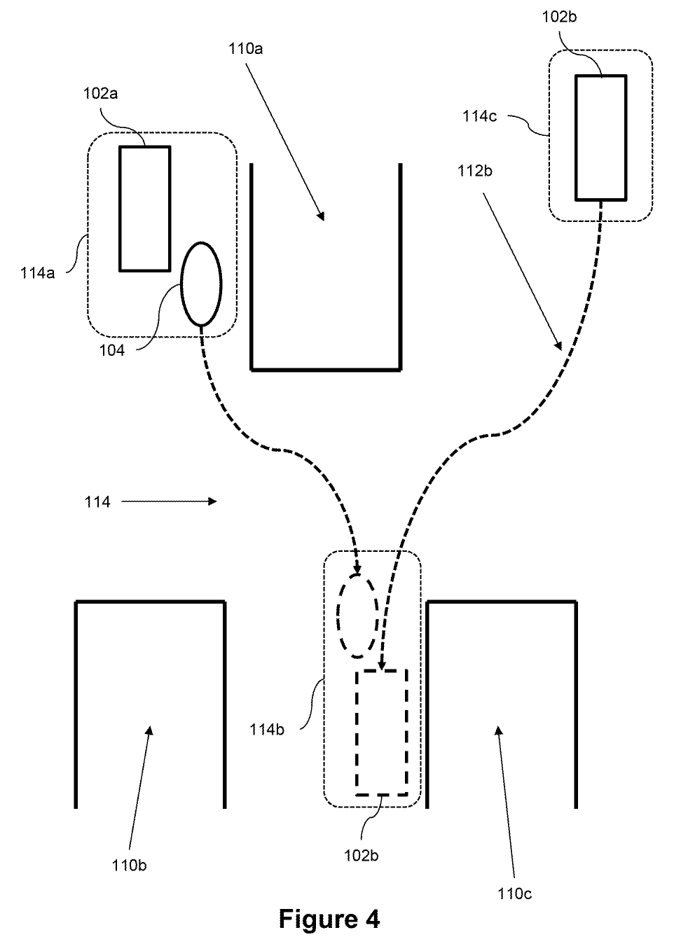

FIG. 4 shows a schematic depiction of an example of an operator 104 which has been assigned to a first autonomous vehicle 102a. The first autonomous vehicle 102a is in a first location 114a near to storage location 110a such that one or more tasks may be performed by the operator. The operator has a mobile terminal (see below), which is connected to the computing platform 200 via one of the wireless base stations. As is disclosed in US9834380, some or all of the display 106 of the first autonomous vehicle 102a is displayed on the display of the mobile terminal. Thus, the operator may see the information relating to the next items to be picked, for example a unique identifier of a storage bin located within the storage location 110a, the location of a storage bin to be accessed on a shield within storage location 110a, etc., without needing to return to the autonomous vehicle to look at the autonomous vehicle display screen.

The operator 104 will be scheduled to perform one or more tasks in conjunction with the first autonomous vehicle 102a. The completion of each of these tasks is acknowledged by the operator, for example by pressing a button on the first autonomous vehicle, by pressing a user interface element on the touch screen of the mobile terminal, etc. Once the last of these scheduled tasks has been completed then the first autonomous vehicle 102a will move to a further location such that additional tasks may be performed by a different operator. For example, the first autonomous vehicle 102a may move to the packing area 130 such that the product eaches which are stored on the first autonomous vehicle can be packed into a number of different customer orders.

As the operator 104 has completed the tasks that are to be performed in conjunction with the first autonomous vehicle 102a then the association between the operator and the first autonomous vehicle 102a can be ended. The scheduled tasks for the operator indicate that the operator is assigned to work in conjunction with a second autonomous vehicle 102b and a second location 114b near to storage location 110c. The computing platform will form an association between the operator and the second autonomous vehicle 102b such that some or all of the display 106 of the second autonomous vehicle 102b is displayed on the display of the mobile terminal. Additionally, the mobile terminal will display to the operator the second location 114b such that the operator can walk to the second location. In one example, the mobile terminal will display to the operator a preferred route to take to the second location 114b. The preferred route may be determined in accordance with known or inferred congestion within the storage environment, for example routing the operator such that they avoid an aisle which is occupied by multiple autonomous vehicles and/or operators. The movement of the operator from the first location 114a to the second location 114b and a position for the operator at the second location 114b are shown in FIG. 4 by a dashed line.

The mobile terminal may also display information relating to one or more tasks to be performed by the operator in conjunction with the second autonomous vehicle 102b. For example, this may include the identity of one or more product eaches to be picked, the storage bins in which each product each is stored, the tote(s) on the second autonomous vehicle into which product each is to be picked, etc. Thus, when the operator and the second autonomous vehicle rendezvous at the second location, the operator is aware of the next task to be performed and does not need to consult the screen 106 of the second autonomous vehicle.

It should be understood that at the time that the computing platform forms an association between the operator and the second autonomous vehicle 102b the second autonomous vehicle may be at a further location 114c within the storage environment. For example, it is likely that the second autonomous vehicle 102b will be moving to the second location 114b from a still different location where other task(s) were being performed. FIG. 4 shows the movement of the second autonomous vehicle 102b from the further location 124c to the second location 114b and a position of the second autonomous vehicle 102b at the second location 114b with a dashed line. It should be understood that the preferred route shown to the operator via the mobile terminal may include an intermediate rendezvous point before the operator and the second autonomous vehicle move to the second location 114b together.

The task(s) which have been assigned to the operator and the second autonomous vehicle 102b will be performed at the second location. Once these task(s) have been performed then the operator may be associated with a yet further autonomous vehicle to perform the tasks which have been assigned to the operator. Similarly, the second autonomous vehicle may move autonomously to another location within the storage environment such that further task(s) which have been assigned to it may be performed.

As has been discussed above, when a new association is formed between an operator and an autonomous vehicle then the mobile terminal mirrors the display screen of the associated autonomous vehicle. Thus, some or all of the information displayed on the autonomous vehicle display screen is displayed by the mobile terminal. This enables the operator to view information relating to upcoming tasks while the operator is walking to meet up with the newly associated autonomous vehicle.

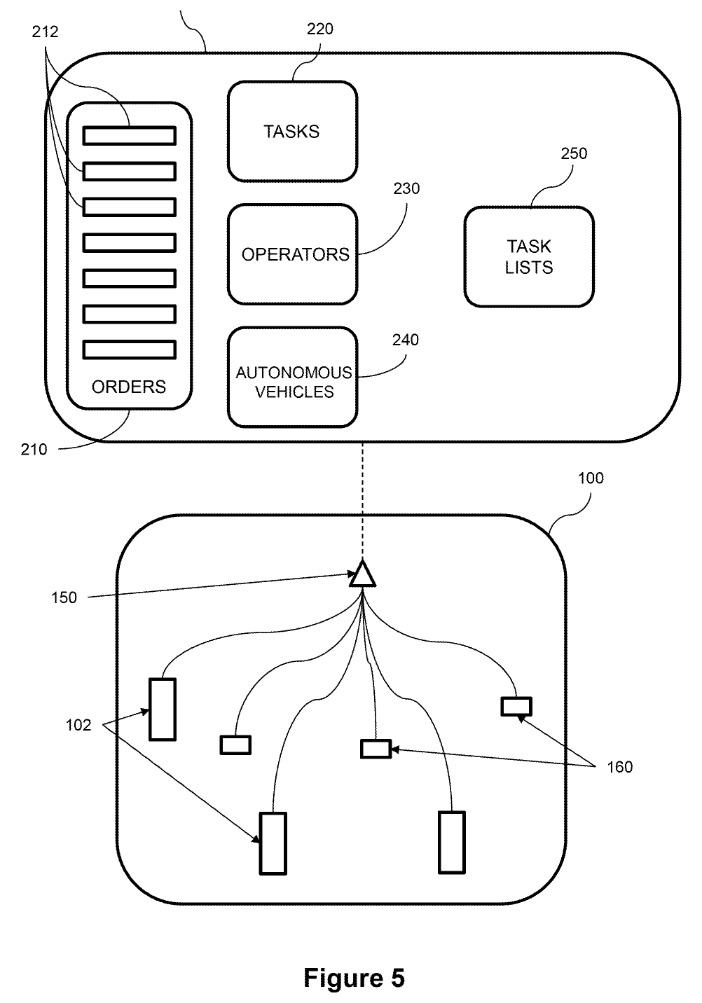

FIG. 5 shows a schematic depiction of the computing platform 200 and the storage environment 100. The computing platform comprises order data 210 which comprises a plurality of received orders 212. Each of the received orders comprise data relating to one or more ordered product items, customer despatch details, order dispatch time, etc. The computing platform 200 further comprises task data 220, operator data 230 and autonomous vehicle data 230. The order data, task data, operator data and the autonomous vehicle data can be processed to determine a task list for each of the operators and each of the autonomous vehicles which will be active within the storage environment. The task list for each autonomous vehicle 102 may be transmitted to the respective autonomous vehicles active in the storage environment 100. Similarly, the task list for each operator may be transmitted to the mobile terminal 160 associated with that operator via the wireless base station 150 and the associated wireless network. The entire task list may be transmitted to an autonomous vehicle or to an operator. In an alternative, a batch comprising one or more tasks may be periodically transmitted to an autonomous vehicle or to an operator. In one example, a batch of tasks to be completed by an operator with a particular autonomous vehicle may be transmitted to the operator and the autonomous vehicle at substantially the same time.

The data associated with each task which is received from the computing platform can be used by an autonomous vehicle to render the display shown on the display screen of the autonomous vehicles. When an operator is associated with one of the autonomous vehicles then the display of the mobile terminal will mirror some or all of the display shown on the display screen of the autonomous vehicle. The mobile terminal may render the display in accordance with the data received from the computing platform relating to the task to be performed. This avoids the need for the autonomous vehicle to transmit data to the mobile terminal of an operator which has been associated with the autonomous vehicle.

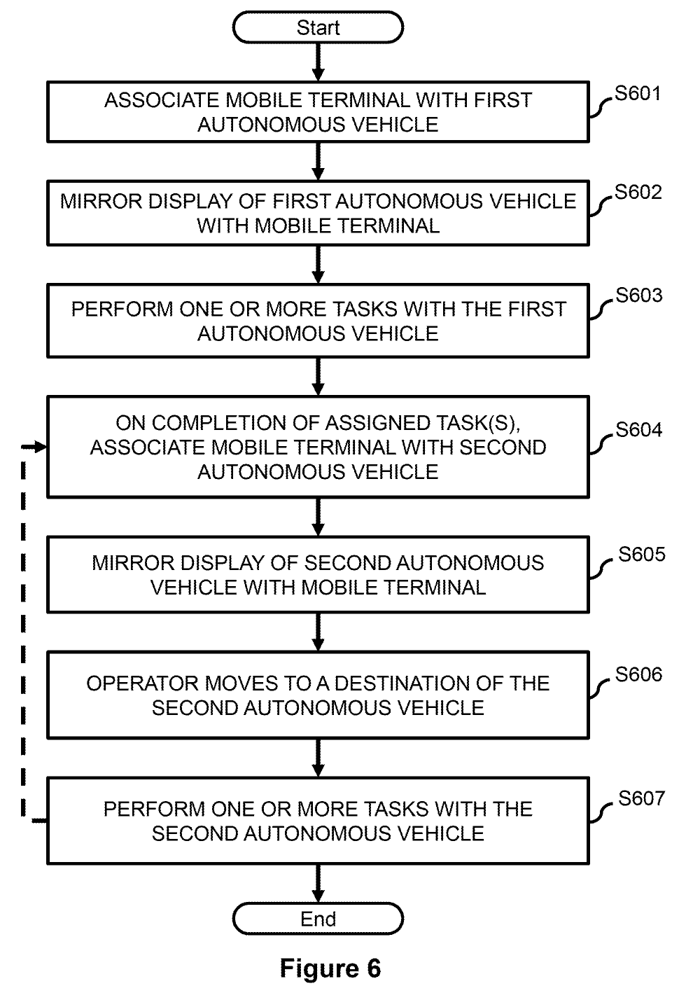

FIG. 6 shows a schematic depiction of a method according to an example of the present disclosure. At step S601, the mobile terminal of an operator is associated with a first autonomous vehicle. This association may be performed automatically by the computing platform in response to the operator activating their mobile terminal within the storage environment, with the computing platform determining which autonomous vehicle that the association is made with in accordance with the task lists which have been generated. In another example, the operator may be informed of the location of the autonomous vehicle which is to be used. The operator may then move to that location and log in to the autonomous vehicle in a conventional manner, for example by scanning a code presented on the display screen, entering a passcode, etc.

At step S602, the display of the first autonomous vehicle is mirrored with the mobile terminal such that some or all of the display of the first autonomous vehicle is displayed by the mobile terminal. At S603, one or more tasks are performed by the operator in conjunction with the first autonomous vehicle. These tasks may be performed at a single location, or the operator may move with the first autonomous vehicle to one or more further locations to perform the one or more tasks.

At step S604, upon completion of the one or more tasks, the mobile terminal is associated with a second autonomous vehicle. At step S605 the display of the second autonomous vehicle is mirrored with the mobile terminal such that some or all of the display of the first autonomous vehicle is displayed by the mobile terminal. The mobile terminal may also display information which enables the operator to move to a second location (step S606), which is the destination of the second autonomous vehicle. Once the operator and the second autonomous vehicle are co-located then the operator may perform one or more tasks in conjunction with the second autonomous vehicle (S607).

The method will then return to step S604, with the operator being assigned to a further autonomous vehicle such that further task(s) may be performed, with steps S604-S607 being iterated as required. When the operator’s shift ends, or the tasks assigned to the operator have been completed, then the method will end.

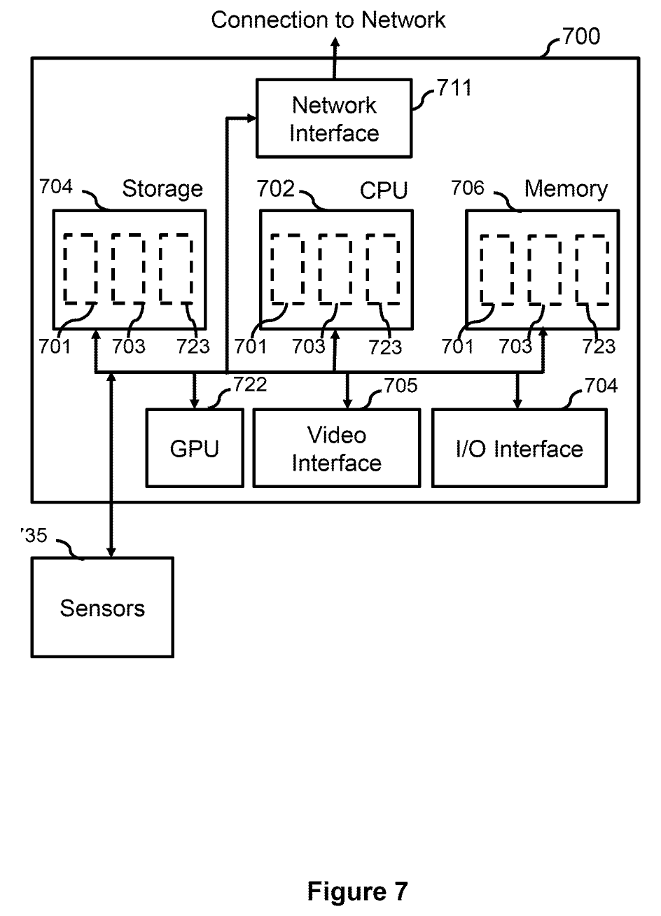

It will be understood that an autonomous vehicle according to the present disclosure may comprise one or more computing devices. FIG. 7 shows a schematic depiction of a computer device 700 that may include a central processing unit (“CPU”) 702 connected to a storage unit 714 and to a random-access memory 706. The CPU 702 may process an operating system 701, application program 703, and data 723. The operating system 701, application program 703, and data 723 may be stored in storage unit 714 and loaded into memory 706, as may be required. Computer device 700 may further include a graphics processing unit (GPU) 722 which is operatively connected to CPU 702 and to memory 706 to offload intensive image processing calculations from CPU 702 and run these calculations in parallel with CPU 702. The computing device may further comprise a network interface 711, for example a WiFi interface or a cellular interface (for example, an interface using LTE technology), to communicate with a warehouse management system and/or other systems operating in the storage environment in which the autonomous vehicle operates. The computer device 700 may receive data from one or more sensors 735. These sensors may comprise the one or more cameras received within the autonomous vehicle, and any other sensors which may be comprised within the autonomous vehicle. Data generated by one or more further sensors may also be received by the computer device and used to control the movement and operation of the autonomous vehicle. Similarly, the computing platform may comprise one or more computing devices substantially as described above with reference to FIG. 7.

It will also be understood that each mobile terminal comprises a computer device in the form of a wearable or handheld device. Wearable computers or handheld terminals for use in warehouse or logistics environments are well known, for example those supplied by Zebra or Honeywell. Such devices may be operated on the Android operating system, and as such may be based on conventional cellular handset hardware. In some examples, the mobile terminal may comprise a scanner, which enables the mobile terminal to easily read barcodes, QR codes, etc. It should be understood that the present disclosure could be implemented by deploying an app to a conventional wearable computer, mobile telephone, etc.

In one respect, there is provided a method of forming an association between a mobile terminal and a first autonomous vehicle. When such an association is made then the display of the first autonomous vehicle is mirrored on the mobile terminal. After one or more tasks gave been performed then the mobile terminal will be associated with a second mobile terminal and the display of the second autonomous vehicle will be mirrored on the mobile terminal.

1. A computer implemented method comprising:
making an association between a first mobile terminal and a first autonomous vehicle;
on the completion of a task performed in conjunction with the first autonomous vehicle, associating the first mobile terminal with a second autonomous vehicle; and
transmitting data to the first mobile terminal such that the first mobile terminal mirrors a display of the second autonomous vehicle.

2. A computer implemented method according to claim 1 wherein the first mobile terminal displays a destination location of the second autonomous vehicle.

3. A computer implemented method according to claim 1 wherein the first mobile terminal displays routing information to a destination location of the second autonomous vehicle.

4. A computer implemented method according to claim 1 wherein the first mobile terminal displays information relating to a task to be performed in conjunction with the second autonomous vehicle.

5. A computer implemented method according to claim 1 wherein the first mobile terminal displays information relating to a product item to be picked to the second autonomous vehicle.

6. A computer implemented method according to claim 1 wherein the first mobile terminal displays information relating to a storage location of a product item to be picked to the second autonomous vehicle.

7. A system comprising one or more processors, a plurality of autonomous vehicles and one or more mobile terminals, the system being configured, in use, to:
make an association between a first mobile terminal and a first autonomous vehicle;
on the completion of a task performed in conjunction with the first autonomous vehicle, associate the first mobile terminal with a second autonomous vehicle; and
transmit data to the first mobile terminal such that the first mobile terminal mirrors a display of the second autonomous vehicle.

8. A system according to claim 7 wherein the data transmitted to the first mobile terminal comprises a destination location of the second autonomous vehicle.

9. A system according to claim 7 wherein the data transmitted to the first mobile terminal comprises routing information to a destination location of the second autonomous vehicle.

10. A system according to claim 7 wherein the data transmitted to the first mobile terminal comprises information relating to a task to be performed in conjunction with the second autonomous vehicle.

11. A system according to claim 10 wherein the data transmitted to the first mobile terminal comprises information relating to a product item to be picked to the second autonomous vehicle.

12. A system according to claim 11 wherein the data transmitted to the first mobile terminal comprises information relating to a storage location of a product item to be picked to the second autonomous vehicle.

13. A non-transitory machine-readable storage medium comprising machine-readable instructions that cause:
an association to be made between a first mobile terminal and a first autonomous vehicle;
an association to be made between the first mobile terminal and a second autonomous vehicle on the completion of a task performed in conjunction with the first autonomous vehicle; and
data to be transmitted to the first mobile terminal such that the first mobile terminal mirrors a display of the second autonomous vehicle.
